(19) United States
(12) Patent Application Publication
(10) Pub. No.: US 2019/0048264 A1
(43) Pub. Date: Feb. 14, 2019

(54) A PROCESS FOR MANUFACTURING OF FIRE SUPPRESSING CRYSTALS

(71) Applicant: DEFLAMO AB, Karlshamn (SE)

(72) Inventor: Fredrik WESTIN, Stockholm (SE)

(21) Appl. No.: 16/078,679

(22) PCT Filed: Feb. 17, 2017
(86) PCT No.: PCT/SE2017/000010

§ 371 Date: Aug. 22, 2018

(30) Foreign Application Priority Data
Feb. 24, 2016 (SE) 1630032.9

(51) Int. Cl. C09K 21/02

(52) U.S. Cl. CPC C09K 21/02

(57) ABSTRACT

A process for the manufacturing of fire suppressing crystals having a high Q-factor particle size distribution, said fire suppression crystals being intended for use as a fire suppressing additive in polymer compositions, the process comprising the steps; a) Preparing a mother liquor comprising water and a salt composition obtained in step c) or d), the temperature of said mother liquor being adjusted to 10-50° C. and comprising said salt composition to a level of at least 90% of saturation. Calcium hydroxide is added to the mother liquor to a level of at least 90% of saturation. b) Preparing an acid solution comprising water and two or more acids selected from the group consisting of; C₂-C₆ mono-, di- and/or tri-carboxylic acids, and optionally a phosphorous compound. The temperature of said acid solution is adjusted to 20-90° C. 31 and comprising acids to a level of at least 50% of saturation. c) The mother liquor, comprising calcium hydroxide, obtained from step a) is subjected to intense agitation under which the acid solution obtained from step b) is slowly added to said mother liquor allowing reaction to form salt until supersaturation is achieved while maintaining PH at a level securing that no unreacted acids remains after reaction, d) Crystals formed in the reaction of step c) is continuously or discontinuously removed from the reaction product of step c).

The present invention relates to a process for the manufacturing of fire suppressing crystals having a high Q-factor particle size distribution, said fire suppression crystals being intended for use as a fire suppressing additive in polymer compositions.

There is a major demand for fire suppressants in the global plastic industry since polymer resins typically have very harmful burning characteristics. They have a high flammability at relative low temperatures and when exposed to fire, the polymeric may material start to drip, which serves to spread the fire, emitting large quantities of smoke and toxic gases.

It is well known in the art that the flammability of polymer resins can be reduced by incorporating fire suppressants. There are many additives with fire suppressing properties available on the market, but unfortunately many of them are toxic and may also release very toxic gases during combustion. Halogenated fire suppressants for instance have an excellent performance but many of these chemicals are associated with health and environmental problems. As a result, several brominated and chlorinated fire suppressants have been forbidden and several more are questioned in the environmentally aware community.

Many prior art references describe the use of different fire suppressants, such as reactive or additive halogenated organic compounds, inorganic fillers, solvents, and special formulations based on phosphorous and ammonium salts. There are for instance mineral fire suppressants that are non-toxic (e.g. aluminium trihydroxide and magnesium dihydroxide) and work by decomposing endothermically. This means that at a certain temperature, the compounds disintegrate thereby adsorbing heat and releasing water vapor. The oxides that are formed results in a protective layer that provides a smoke suppressing and oxygen depriving effect. Despite the obvious advantages of mineral fire suppressants, it is not always possible to replace halogenated fire suppressants. To reach flammability standards in demanding applications, mineral fire suppressants need to be added in very high dosage levels (up to 80% by weight). Such high levels of additives will radically deteriorate the physical properties of the polymer.

The interaction between the polymer resin and the fire suppressant is rather complex. The fire suppressant property of an additive in a polymer formulation varies very much with the nature of the substrate, especially for intumescent compositions, where the rapid formation of a protective char is highly dependent on combustion temperature and viscosity of the melt formed by the burning substrate.

One, often overlooked problem, is that the efficiency factor of the fire suppressant utilized is heavily depending on how well it is distributed in the polymer composition. This is especially true for fire suppression systems having multiple components and hence multiple effects. In cases where the fire suppressant is present in the form of particles, the size of said particles becomes a very important part of the distribution problem. A well-defined particle size distribution is indeed desired. It is possible to solve this by grinding the produced fire suppressing particles and then to sieve the grinded product into desired fractions. There is however some problems that follows with this procedure. It will call for extra steps in the production which will increase cost. The grinded particles will also have sharp edges that naturally grown crystals seldom have. These sharp, grinded particles will cause unnecessary wear of equipment used down-stream such as agglomerating equipment where polymers are mixed with the fire suppressing particles. These sharp, grinded particles will further cause wear in many parts of injection molding machines, primarily plasticizing screws, injection nozzles and molds. Other equipment that will suffer from wear is film blowing machines and extruders. Such wear will reduce the useful life of such equipment. Sharp grinded particles will also affect mechanical properties of the polymers in which they are embedded, by for example act as initiators for fractures.

The invention accordingly relates to a novel process for the manufacturing of fire suppressing crystals having a high Q-factor particle size distribution, said fire suppression crystals being intended for use as a fire suppressing additive in polymer compositions, the process comprising the steps;
a) A mother liquor is prepared, comprising water and a salt composition obtained in step c) or d). The temperature of the mother liquor is adjusted to a selected temperature in the range 10-50° C. and comprises said salt composition to a level of at least 90% of saturation at the selected mother liquor temperature. Calcium hydroxide is added to the mother liquor to a level of at least 90% of saturation.
b) An acid solution is prepared, comprising water and two or more acids selected from the group consisting of; C₂-C₆ mono-, di- and/or tri-carboxylic acids, and optionally a phosphorous compound selected from the group consisting of; polyphosphoric, pyrophosphoric, phosphoric acid or a combination thereof. The temperature of said acid solution is adjusted to a level in the range 20-90° C. and comprises acids to a level of at least 50% of saturation at the selected acid solution temperature.
c) The mother liquor, comprising calcium hydroxide, obtained from step a) is subjected to intense agitation under which the acid solution obtained from step b) is slowly added to said mother liquor allowing reaction to form salt until supersaturation is achieved while maintaining PH at a level securing that no unreacted acids remains after reaction.
d) Crystals formed in the reaction of step c) is continuously or discontinuously removed from the reaction product of step c).

According to one embodiment of the invention the PH in the reactor is kept above 8.

According to one alternative embodiment of the invention the fire suppressing crystals have a core of calcium carbonate. In all essential, the process is identical to the one described above. For the sake of clarity the process steps, with modification for incorporating a core of calcium carbonate is described below. Also this alternative embodiment relates to a process for the manufacturing of fire suppressing crystals having a high Q-factor particle size distribution, said fire suppression crystals being intended for use as a fire suppressing additive in polymer compositions, the process comprising the steps;
a) A mother liquor is prepared, comprising water and a salt composition obtained in step c) or d). The temperature of said mother liquor is adjusted to a selected temperature in the range 10-50° C. and comprising said salt composition to a level of at least 90% of saturation at the selected mother liquor temperature. Calcium hydroxide is added to the mother liquor to a level of at least 90% of saturation. In this, the alternative embodiment of the invention also fire suppression synergist particles is added. Accordingly the fire suppressant synergist particles, having an average particle size in the range 0.3-1 μm, are suspended in said mother liquor to a level of 1-25% by weight of the calcium hydroxide. It is here important to provide sufficient agitation in order to keep the fire suppressant synergist particles in suspension.
b) An acid solution is prepared, comprising water and two or more acids selected from the group consisting of; C₂-C₆ mono-, di- and/or tri-carboxylic acids, and optionally a phosphorous compound selected from the group consisting of; polyphosphoric, pyrophosphoric, phosphoric acid or a combination thereof, wherein the temperature of said acid solution is adjusted to a level in the range 20-90° C. and comprising acids to a level of at least 50% of saturation at the selected acid solution temperature, whereupon,
c) The mother liquor, comprising calcium hydroxide and suspended fire suppressant synergist particles, obtained from step a) is subjected to intense agitation under which the acid solution obtained from step b) is slowly added to said mother liquor allowing reaction to form salt until supersaturation is achieved while maintaining PH at a level securing that no unreacted acids remains after reaction.
d) The crystals formed in the reaction of step c) are continuously or discontinuously removed from the reaction product of step c).

Said suspended fire suppressant synergist particles are acting as seeding particles for crystallization of said salt. The fire suppressant synergist will then be in the center of the crystals which is advantageous as each crystal will then include all components active in fire suppression. The fire suppressant synergist particles are preferably selected from the group consisting of; calcium carbonate [CaCO₃], aluminum trihydroxide [Al(OH)³], magnesium dihydroxide [Mg(OH)₂], huntite [Mg₃Ca(CO₃)₄], dolomite [CaMg(CO₃)₂], magnesite [MgCO₃], hydromagnesite [Mg₅(CO₃)₄(OH)₂.4H₂O], tricalciumphosphate [Ca₃(PO₄)₂], hydroxylapatite [Ca₁₀(PO₄)₆(OH)₂] and combinations thereof.

According to one embodiment of the invention the PH in the reactor is kept above 8.

According to a preferred embodiment of the invention, the reaction performed in step c) is achieved in a reactor. Said reactor is then provided with means for controlling temperature in the range 10-60° C. and pressure in the range 0.5-5 Bar.

The acid solution obtained in step b) added in step c) is, above being added slowly, advantageously, also finely distributed into small droplets. It is also, depending on the design of the reactor, advantageous to add the acid solution in a steady uninterrupted stream during the reaction phase. This is especially important in flow-type reactors such as tube reactors or plate reactors. A good distribution can be achieved by any known means such as through a pressurized fluid spray nozzle, piezo-electric micronization, thin-film distribution or the like.

The reaction will produce an amount of water. The process is advantageously provided with means for ejection of this surplus water. The surplus water can then be removed through a simple overflow or through evaporation.

The crystallization may suitable be controlled by means of lowering temperature and/or pressure in the reactor.

According to one embodiment of the invention the crystallization is performed outside the reactor by means of lowering temperature, pressure and/or evaporation of water.

The crystallization can be performed outside the reactor by pumping a controlled stream from the reactor into precipitation chamber. The temperature and/or pressure is then guided in said precipitation chamber to control crystal growth and size. Crystals above a desired size are separated from the controlled stream. The stream is then fed back to the reactor and/or the mother liquor of claim 1 step a). There are many known ways to remove the crystals from the water solution but some type of continuous means of separation such as band-filter or decanter centrifuge is preferred.

The obtained crystals are suitably dried at a temperature not exceeding 140° C., optionally after rinsing with fresh water. It may be necessary to de-agglomerate the crystals. A simple mechanical solution is in most cases sufficient, however grinding should be avoided not to destroy the naturally grown crystals. It is also possible to utilize a sieve to remove any agglomerates of crystals.

The obtained crystals have an average particle size in the range 0.2-50 μm. In a preferred embodiment of the invention the obtained crystals have an average particle size in the range 0.2-20 μm. The size of the crystals can indeed be controlled by means of the according to the invention and a surprisingly narrow particles size distribution can be achieved.

“A high Q-factor particle size distribution” is to be understood as that the deviation in particle size is low. In a batch of crystals being produced to have the average particle size of say 5 μm a surprisingly small amount will be below 2.5 μm and more importantly an also surprisingly small amount will be above 10 μm. The crystal size deviation from average crystal particle size for a produced batch is preferably <10% by weight having half the average particle size and <5% by weight having twice the average particle size. A uniform particle size is very important in most cases, especially when producing polymers with thin goods like plastic films where an adequate distribution of fire suppressant will be impossible to achieve with big deviations in particle size. The film itself may also contain flaws like pinholes caused by particularly large particles. Sharp, grinded particles may also come to be the initiation point of stress fractures in certain polymer materials. A naturally grown crystal is therefore a much better alternative than a grinded particle.

The process of achieving the desired crystal size is suitably guided by means of statistical process guiding by means of controlling concentration levels of salt in the reactor, temperature in the reactor, flow in the reactor and pressure in the reactor.

According to yet another embodiment of the invention the crystal size is guided by means of statistical process guiding by means of controlling parameters in the reactor selected from the group consisting of; concentration levels of salt in the reactor, temperature in the reactor, pressure in the reactor, flow speed in the reactor, concentration levels of salt in the precipitation chamber, residence time in the precipitation chamber, temperature in the precipitation chamber and a combination thereof.

According to one embodiment of the invention said at least two acids are selected from the group consisting of; ethanoic acid, ethanedioic acid, oxoethanoic acid, 2-hydroxyethanoic acid, propanoic acid, prop-2-enoic acid, propanedioic acid, 2-oxopropanoic acid, 2-hydroxypropanoic acid, butanoic acid, 2-methylpropanoic acid, butanedioic acid, 3-oxobutanoic acid, butenedioic acid, oxobutanedioic acid, hydroxybutanedioic acid, 2,3-dihydroxybutanedioic acid, but-2-enoic acid, pentanoic acid, pentanedioic acid, 2-oxopentanedioic acid, hexanoic acid, hexanedioic acid, 2-hydroxypropane-1,2,3-tricarboxylic acid, prop-1-ene-1,2,3-tricarboxylic acid, 1-hydroxypropane-1,2,3-tricarboxylic acid, propane-1,2,3-tribarboxylic acid and hexa-2,4-dienoic acid. Suitably at least one of said at least two acids is a di- or tricarboxylic acid.

In the embodiment of the invention where calcium carbonate has not been added to the mother liquor, particles of calcium carbonate having an average particle size of 0.3-2 μm can be added before or after drying of the crystals obtained in step d) so that said calcium carbonate is present to a level of 1-30% by weight of the crystals.

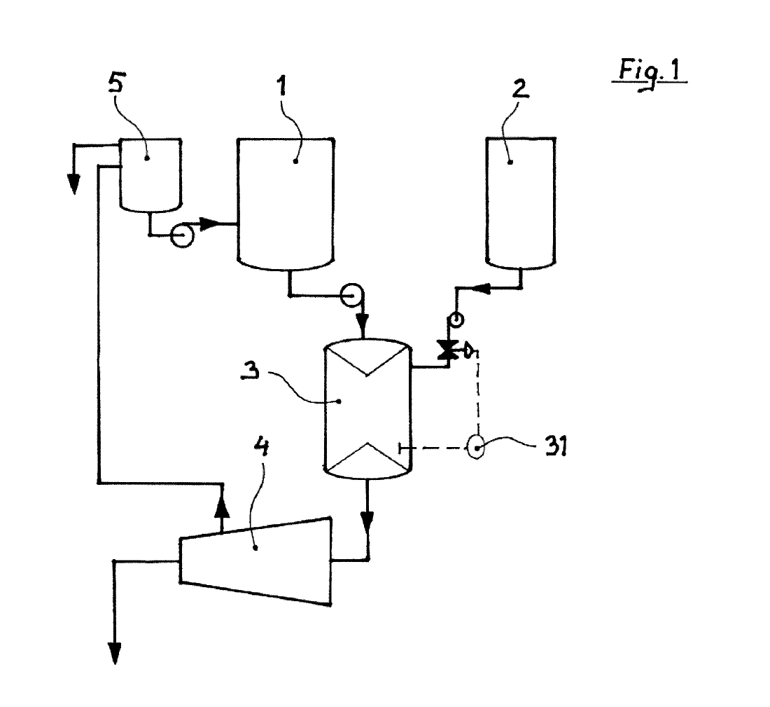

The invention is further described together with FIG. 1.

FIG. 1 shows a process for manufacturing the fire suppressing crystals comprising the steps;
a) A mother liquor comprising water and a salt composition obtained in step c) as a depleted mother liquor from step d), is prepared in a mother liquor vessel 1. The temperature of said mother liquor is adjusted to 15° C. and comprising said salt composition to a level of at least 90% of saturation. Calcium hydroxide is added to the mother liquor to a level of at least 90% of saturation.
b) An acid solution comprising water, ethanedioic acid, 2,3-dihydroxybutanedioic acid and phosphoric acid is prepared in an acid solution vessel 2. The temperature of said acid solution is adjusted to 50° C. and comprises acids to a level of at least 50% of saturation. The ratio between the acids are ⅓ per weight of each of the above listed.
c) The mother liquor, comprising calcium hydroxide, obtained from step a) is subjected to intense agitation by being propelled through a tube reactor 3. The mother liquor is made essentially free from solid particles by means of filtration. The acid solution obtained from step b) is slowly and steadily added to said mother liquor, allowing reaction to form salt so that supersaturation is achieved while maintaining PH at a level securing that no unreacted acids remains after reaction. The adding of the acid solution is accordingly guided by a guiding means 31. The reactor is also provided with cooling to remove exothermal energy from the reaction.
d) The crystals formed in the reaction of step c) are continuously removed from the reaction product of step c) by means of a decanter centrifuge 4. The remaining reaction product, now free from crystals of the desired size, is then, in its depleted form, pumped back to the mother liquor vessel 1 via an overflow vessel 5 where excess water is removed. The crystals having an average particle size of 4 μm is then de-agglomerated and dried. Each individual crystal produced comprises the components of step a) and b).

The embodiment described shall not be perceived as a limitation of the scope of the present invention. It is for example possible to select other combination of acids within the scope of the invention. Temperatures and ratios between acids selected are, depending on the properties desired in the fire suppression crystals, possible to adjust within the scope of the invention. It is accordingly also possible to add calcium carbonate particles to the mother liquor within the scope of the invention.

1. A process for the manufacturing of fire suppressing crystals having a high Q-factor particle size distribution, the process comprising:
a) preparing a mother liquor comprising water and a salt composition obtained in c) or d), the temperature of said mother liquor being adjusted to a selected temperature in the range 10-50° C. and comprising said salt composition at a level of at least 90% of saturation at the selected mother liquor temperature, and calcium hydroxide is added to the mother liquor to a level of at least 90% of saturation,
b) preparing an acid solution comprising water and two or more acids selected from the group consisting of: C₂-C₆ mono-, di- and tri-carboxylic acids, or a combination thereof, and optionally a phosphorous compound selected from the group consisting of: polyphosphoric, pyrophosphoric, and phosphoric acid or a combination thereof, wherein the temperature of said acid solution is adjusted to a level in the range 20-90° C. and comprises acids at a level of at least 50% of saturation at the selected acid solution temperature, whereupon,
c) the mother liquor, comprising calcium hydroxide, obtained from a) is subjected to intense agitation under which the acid solution obtained from b) is slowly added to said mother liquor allowing reaction to form salt until supersaturation is achieved while maintaining PH at a level ensuring that no unreacted acids remains after reaction and,
d) crystals formed in the reaction of c) are continuously or discontinuously removed from the reaction product of c).

2. A process according to claim 1, wherein fire suppressant synergist particles have an average particle size in the range 0.3-1 μm and are suspended in the mother liquor at a level of 1-25% by weight of the calcium hydroxide added.

3. A process according to claim 2, wherein said suspended fire suppressant synergist particles act as seeding particles for crystallization of said salt, and the fire suppressant synergist particles are selected from the group consisting of: calcium carbonate, aluminum trihydroxide magnesium dihydroxide, huntite, dolomite, magnesite, hydromagnesite, tricalciumphosphate, hydroxylapatite, and combinations thereof.

4. A process according to claim 1, wherein the reaction performed in c) is achieved in a reactor that maintains temperature in the range of 10-60° C. and pressure in the range of 0.5-5 Bar.

5. A process according to claim 1, wherein the acid solution obtained in b) added in c) is finely distributed into small droplets.

6. A process according to claim 5, wherein the process comprises ejection of surplus water.

7. A process according to claim 5, wherein crystallization is controlled by lowering temperature and/or lowering pressure in the reactor.

8. A process according to claim 5 wherein crystallization is performed outside the reactor by of lowering temperature, by lowering pressure and/or by evaporation of water.

9. A process according to claim 5, wherein crystallization is performed outside the reactor by pumping a controlled stream from the reactor into a precipitation chamber, wherein, the temperature and/or pressure is guided in said precipitation chamber to control crystal growth and size, and crystals above a desired size are separated from the controlled stream which then are fed back to the reactor and/or the mother liquor of claim 1 a).

10. A process according to claim 1, wherein the obtained crystals are dried at a temperature not exceeding 140° C., optionally after rinsing with fresh water.

11. A process according to claim 10, wherein the obtained crystals have an average particle size in the range of 0.2-50 μm.

12. A process according to claim 10, wherein the obtained crystals have an average particle size in the range of 0.2-20 μm.

13. A process according to claim 5, wherein the PH in the reactor is kept above 8.

14. A process according to claim 5, wherein the crystal size is guided by controlling concentration levels of salt in the reactor, temperature in the reactor, flow in the reactor and pressure in the reactor.

15. A process according to claim 9, wherein the crystal size is guided by controlling parameters in the reactor selected from the group consisting of: concentration levels of salt in the reactor, temperature in the reactor, pressure in the reactor, flow speed in the reactor, concentration levels of salt in the precipitation chamber, residence time in the precipitation chamber, temperature in the precipitation chamber and a combination thereof.

16. A process according to claim 11, wherein the crystal size deviation from average crystal particle size for a produced batch is <10% by weight having half the average particle size and <5% by weight having twice the average particle size.

17. A process according to claim 1, wherein said at least two acids are selected from the group consisting of: ethanoic acid, ethanedioic acid, oxoethanoic acid, 2-hydroxyethanoic acid, propanoic acid, prop-2-enoic acid, propanedioic acid, 2-oxopropanoic acid, 2-hydroxypropanoic acid, butanoic acid, 2-methylpropanoic acid, butanedioic acid, 3-oxobutanoic acid, butenedioic acid, oxobutanedioic acid, hydroxybutanedioic acid, 2,3-dihydroxybutanedioic acid, but-2-enoic acid, pentanoic acid, pentanedioic acid, 2-oxopentanedioic acid, hexanoic acid, hexanedioic acid, 2-hydroxypropane-1,2,3-tricarboxylic acid, prop-1-ene-1,2,3-tricarboxylic acid, 1-hydroxypropane-1,2,3-tricarboxylic acid, propane-1,2,3-tribarboxylic acid and hexa-2,4-dienoic acid, and at least one of said at least two acids is a di- or tricarboxylic acid.

18. A process according to claim 10, wherein the process further comprises adding calcium carbonate particles having an average particle size of 0.3-2 μm before or after drying so that said calcium carbonate is present at a level of 1-30% by weight of the crystals.
